(19) United States
(12) Patent Application Publication
(10) Pub. No.: US 2006/0230111 A1
(43) Pub. Date: Oct. 12, 2006

(54) Method for allowing peer-to-peer data transmission

(75) Inventors: Frank-Uwe Andersen, Berlin (DE); Hermann De Meer, Passau (DE); Ivan Dedinski, Passau (DE); Tobias Hossfeld, Wurzburg (DE); Cornelia Kappler, Berlin (DE); Andreas Maeder, Zel am Main (DE); Jens Oliver Oberender, Passau (DE); Phuoc Tran-Gia, Wurzburg (DE); Kurt Tutschku, Gerbrunn (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munich (DE)

(21) Appl. No.: 11/324,161

(22) Filed: Jan. 3, 2006

Related U.S. Application Data
(63) Continuation of application No. 11/117,697, filed on Apr. 29, 2005, now abandoned.

(30) Foreign Application Priority Data
Apr. 30, 2004 (DE) 10 2004 023 652.6

(51) Int. Cl. G06F 15/16

(52) U.S. Cl. 709/205

(57) ABSTRACT

Method for allowing peer-to-peer data transmission The invention relates to a method for allowing peer-to-peer data transmission between peer communication terminals. In this context, a file (D), for which multiple requests regarding retrieval have already been sent to an index server (IS) by peer communication terminals in the past, is automatically retrieved from a peer communication terminal (P3) providing this file by a storage peer communication terminal (SP). This file (D) is stored in the storage peer communication terminal (SP). The storage peer communication terminal (SP) registers as a provider of this file with the index server (IS). Upon receiving a further request relating to this file (D), the index server provides the requesting peer communication terminal with an address for the storage peer communication terminal in order to allow the requesting peer communication terminal to retrieve the file (D) from the storage peer communication terminal (SP).

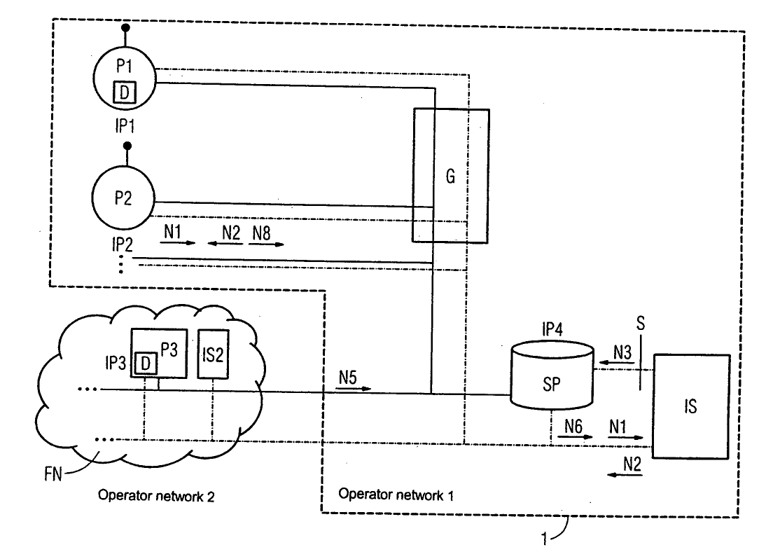

### CLAIM FOR PRIORITY

This application claims priority to German Application No. 10 2004 023 652.6 filed Apr. 30, 2004, which is incorporated herein, in its entirety, by reference.

The invention relates to a method for allowing peer-to-peer data transmission between peer communication terminals.

Peer-to-peer data transmissions, in which peer communication terminals (often simply called “peers”) are connected to one another via a network, are general knowledge. The peer communication terminals can each perform the functions of either server or client during peer-to-peer data transmission. By way of example, a peer communication terminal can provide files (e.g. music files) for other peer communication terminals and can also retrieve them therefrom. The peer communication terminals can thus provide services for other peer communication terminals and can also retrieve services from other peer communication terminals. In this context, the peer communication terminals have equal authority among one another. The peer-to-peer data transmission between peer communication terminals differs from the data transmission between client and server computers in client/server communication networks. In the case of client/server data transmission, a communication terminal operates either as a server (which provides a service for another communication terminal) or as a client (which retrieves a service from a server). In the case of peer-to-peer data transmission, data are held locally in various peer communication terminals and are transmitted between them.

Central servers (known as “index servers”) store the information regarding which peer communication terminal holds the various data or files. When a peer communication terminal wishes to obtain a file, this peer communication terminal asks the index server for the address of a further peer communication terminal which holds the desired file. The peer communication terminal then retrieves the file directly from the further peer communication terminal.

Peer-to-peer data transmissions today give rise to a considerable proportion of the data transmission volume which arises in telecommunication networks. It is estimated that between 50 and 80% of the data volume transmitted via the Internet comes from peer-to-peer data transmissions.

The invention is based on the object of specifying a method and an arrangement which can be used to provide frequently requested files for peer-to-peer data transmission easily and reliably.

The invention achieves this object by means of a method for allowing peer-to-peer data transmission between peer communication terminals with the following steps:
a file, for which multiple requests regarding retrieval have already been sent to an index server by peer communication terminals in the past, is automatically retrieved from a peer communication terminal providing this file by a storage peer communication terminal,
this file is stored in the storage peer communication terminal,
the storage peer communication terminal registers as a provider of this file with the index server, and
the index server, upon receiving a further request relating to this file, provides the requesting peer communication terminal with an address for the storage peer communication terminal in order to allow the requesting peer communication terminal to retrieve the file from the storage peer communication terminal.

A particular advantage of this method is that a “popular” file (that is to say a file for which multiple requests have already been sent to the index server) is automatically retrieved by the storage peer communication terminal, stored therein and then provided thereby. As soon as further requests regarding this file arrive on the index server, the index server transmits the address of the storage peer communication terminal to the requesting peer communication terminal. This “popular” file is then transmitted from the storage peer communication terminal to the requesting peer communication terminal. This allows the data transmission path to be stipulated for this “popular” file: the file is transmitted from the storage peer communication terminal to the requesting peer communication terminal. This particularly avoids the need for “popular” files to be reloaded from (possibly different, mobile and/or slow) peer communication terminals providing this file upon every new request.

The inventive method may proceed in the following manner: the file, for which multiple requests regarding retrieval have already been sent to the index server by peer communication terminals in the past, is automatically retrieved from the peer communication terminal providing this file by the storage peer communication terminal by virtue of
the index server sending an identifier for the file and an address for the peer communication terminal providing this file to the storage peer communication terminal, and
the storage peer communication terminal then retrieving the file characterized by the identifier from the peer communication terminal associated with the address.

This allows the index server (in which the number of requests which appear can easily be monitored) to stipulate which file needs to be stored in the storage peer communication terminal.

The inventive method may have the following method steps: the index server, upon receiving the further request relating to this file, provides the requesting peer communication terminal with the address of the storage peer communication terminal by virtue of the index server arranging the address of the storage peer communication terminal at the first position in an address list which is provided for holding addresses for peer communication terminals which provide the file, and the index server transmitting this address list to the requesting peer communication terminal,

The effect advantageously achieved by this is that the requesting peer communication terminal will retrieve the desired file from the storage peer communication terminal and not from other peer communication terminals which may also be present which likewise provide the file. This is because normally the requesting peer communication terminal will retrieve the file from the peer communication terminal whose address is arranged at first position in the address list.

The inventive method may have the following step: if addresses are already arranged at the second, the third and/or lower listed positions then the index server deletes these addresses.

The effect advantageously achieved by this is that the address list is used to transmit only the address of the storage peer communication terminal to the requesting peer communication terminal, which means that the requesting peer communication terminal actually retrieves the file from the storage peer communication terminal.

The inventive method may be in a form such that the peer communication terminals are in the form of mobile terminals in a mobile radio network and such that a storage peer communication terminal is used which is arranged in a stationary part of a mobile radio network. A particular advantage in this context is that the files stored in the storage peer communication terminal need to be transmitted only once via the air interface of the mobile radio network when they are retrieved (namely from the storage peer communication terminal to the requesting peer communication terminal). It is not necessary to transmit the file twice via the air interface (namely from the providing peer communication terminal to the stationary part of the mobile radio network and back to the requesting peer communication terminal).

The inventive method may be in a form such that a storage peer communication terminal is used which is arranged in the same operator network as the index server. An advantage in this context is that when a file is retrieved this file is already stored in the network operator's network which also contains the index server. It is therefore possible to avoid data transmissions which go beyond the boundaries of operator networks, which means that it is possible to avoid the costs which arise for such data transmissions going beyond the boundaries of operator networks.

The inventive method may have the following method step: the index server identifies the storage peer communication terminal from its ping message response time, which is short in comparison with other peer communication terminals.

This means that the index server can automatically distinguish the storage peer communication terminal from other peer communication terminals providing files.

The inventive method may have the following provision: if the file which has already received multiple requests in the past is provided by a plurality of peer communication terminals then this file is retrieved by the storage peer communication terminal from the selected-peer communication terminal in the plurality which has the shortest ping message response time among the peer communication terminals in the plurality.

An advantage in this context is that the file can be transmitted to the storage peer communication terminal in a short time and that the file is transmitted (when possible) to the storage peer communication terminal from a peer communication terminal which is permanently connected to the peer-to-peer data transmission network and not from a mobile peer communication terminal. This is because mobile peer communication terminals have comparatively long ping message response times on account of their linkage via the air interface.

The inventive method may involve the following method step being performed: the storage peer communication terminal converts short data transmission blocks, which are used by peer communication terminals in the form of mobile terminals, into long data transmission blocks, which are used by peer communication terminals arranged in stationary parts of telecommunication networks, and vice versa.

It is advantageous, for the peer-to-peer data transmission from and to mobile peer communication terminals, to use data transmission blocks (file segments, “chunks”) which are shorter than those data transmission blocks which are used for the peer-to-peer data transmission from and to fixed-location peer communication terminals. This is because data transmission blocks always need to be transmitted in full; following the full transmission of a data transmission block (for example using CRC (Cyclic Redundancy Check) methods) the error-free transmission of the data transmission block is checked. Since the data transmission quality in peer communication terminals which use air interfaces is frequently lower than the data transmission quality for line-connected data transmissions, data transmission blocks need to be resent more often in the case of mobile peer communication terminals. The use of shorter data transmission blocks keeps the data traffic additionally generated as a result within acceptable limits. In addition, the use of shorter data transmission blocks allows the likelihood of error-free transmission to be increased. Since the “long” data transmission blocks used for line-connected data transmission often have a size of approximately 9 Mbytes, it is also advantageously possible to use the shorter data transmission blocks for transmitting short files (e.g. with a size in the region of several hundred Kbytes), in particular.

The invention likewise achieves the aforementioned object by means of an arrangement having a storage peer communication terminal and an index server, in which
the index server is designed to send an identifier for a file and an address for a peer communication terminal which provides this file to the storage peer communication terminal,
the storage peer communication terminal is designed for automatically retrieving the file identified by the identifier from the peer communication terminal associated with the address,
the storage peer communication terminal is designed for automatically storing this file,
the storage peer communication terminal is designed for automatically registering as a provider of this file with the index server, and
the index server is designed such that, upon receiving a further request which relates to this file, it provides the requesting peer communication terminal with an address for the storage peer communication terminal in order to allow the requesting peer communication terminal to retrieve the file from the storage peer communication terminal.

A particular advantage in this context is that the index server and the storage peer communication terminal are designed for direct communication with one another, and the index server uses this communication to prompt the storage peer communication terminal to retrieve the file, store it and then to register as a provider of this file with the index server. In addition, the index server is designed such that when the storage peer communication terminal has registered successfully it provides the address of the storage peer communication terminal for the further requests relating to this file.

In this arrangement, the peer communication terminal may be in the form of a mobile terminal in a mobile radio network. The storage peer communication terminal may be arranged in a stationary (fixed-location) part of a mobile radio network.

In addition, the storage peer communication terminal may be arranged in the same operator network as the index server.

The variants of the inventive arrangement which have just been mentioned advantageously avoid the files being transmitted multiple times via the air interface of the mobile network or the files being transmitted multiple times beyond operator network boundaries.

The arrangement may be in a form such that the storage peer communication terminal is designed to convert short data transmission blocks, which are used by peer communication terminals in the form of mobile terminals, into long data transmission blocks, which are used by peer communication terminals arranged in stationary parts of telecommunication networks, and vice versa. This advantageously allows files coming from mobile communication terminals also to be effectively transmitted to peer communication terminals which are arranged in stationary parts of telecommunication networks, and vice versa. This is because the use of shorter data transmission blocks—as already explained above—keeps the data traffic additionally generated when erroneous data transmissions occur within acceptable limits. In addition, the use of shorter data transmission blocks allows the likelihood of error-free transmission to be increased.

To explain the invention further, the figure shows an exemplary embodiment of the inventive arrangement and an exemplary embodiment of the inventive method.

The figure shows a first mobile peer communication terminal P1 (mobile peer) and a second mobile peer communication terminal P2. The mobile peer communication terminals P1 and P2 may be mobile telephones, for example, or may be computers or personal digital assistants with a mobile radio interface. The bottom left-hand part of the figure schematically shows a peer-to-peer landline network FN (P2P landline network, fixed P2P network). This landline network FN has a stationary peer communication terminal P3 (fixed-location peer communication terminal, fixed peer) installed in it and also further stationary peer communication terminals (not shown). The stationary peer communication terminal P3 and the further peer communication terminals are computers connected to the Internet by a data line, for example. The stationary peer communication terminal P3 has an associated address in the form of an IP address IP3. The peer-to-peer landline network FN may be the Internet, for example.

The mobile peer communication terminal P1 and the mobile peer communication terminal P2 belong to a first operator network 1 (“operator network 1”, first operator domain) belonging to a first network operator in a mobile radio network; they are thus under the control of the first network operator. (In another exemplary embodiment, the first network operator may also be an operator of a landline Internet). The first network operator can transmit data within the first operator network 1 at the cost-of-sale price, i.e. he does not need to make any payments to other network operators for transmitting data. The area of the first operator network 1 is symbolized by a dashed line. The mobile peer communication terminal P1 has an associated address in the form of an IP address IP1; the mobile peer communication terminal P2 has an associated address in the form of an IP address IP2.

The peer-to-peer landline network FN is a second operator network (“operator network 2”, second operator domain) in a second network operator; it is thus under the control of the second network operator. The second network operator can transmit data within the second operator network at the cost-of-sale price, i.e. he does not need to make any payments to other network operators for transmitting data. The peer-to-peer landline network FN contains a second index server IS2.

The peer communication terminals P1, P2 and P3 and also the further peer communication terminals of the landline network FN are connected to one another via a gateway G (which is a Gateway GPRS Support Node (GGSN) in the exemplary embodiment). The user-data interchange (file exchange) between the peer communication terminals is shown by means of a solid line in the figure. In line with the invention, the user data in the form of files may also be transmitted to a storage peer communication terminal SP (storage peer, caching peer) which is arranged in the same operator network as an index server IS. The gateway G, the storage peer communication terminal SP and the index server IS likewise belong to the first operator network 1 (“operator network 1”) of the first network operator. The storage peer communication terminal SP has an associated address in the form of an IP address IP4.

The peer communication terminals, the gateway G, the storage peer communication terminal SP and the index server IS interchange signaling messages; the data transmission channel for these signaling messages is symbolized in the figure by means of a dash-dot line. The index server IS and the storage peer communication terminal SP interchange special signaling messages. This message interchange is effected via an interface S and is symbolized by a dash-dot line.

The mobile peer communication terminals P1 and P2 are in the form of communication terminals in a mobile radio network. The mobile radio network also includes the gateway G, the storage peer communication terminal SP and the index server IS. The other elements which are always present in mobile radio networks, such as base stations, switching centers etc., are not shown in the figure. The mobile peer communication terminals P1 and P2 are situated in the stationary part of the mobile radio network; the storage peer communication terminal SP, the index server IS and the gateway G are situated in the stationary part of the mobile radio network (landline part of the mobile radio network, e.g. in the packet switched domain of 2.5/3G telecommunication networks).

The text below uses the arrangement shown in the figure to describe an exemplary embodiment of the inventive method.

A file D (e.g. a music file, a file containing high-quality economic information or the like) is held and provided by the mobile peer communication terminal P1 and by the peer communication terminal P3 in the landline network. Within the context of this invention, the term “file” means a complete file or else file segments. The mobile peer communication terminal P2 sends a request message N1 relating to the file D via the gateway G to the index server IS. The peer terminal P2 uses this request message N1 to ask the index server IS which peer communication terminals hold the file D. The request message N1 may contain a name for the file, for example. (Alternatively, the request message N1 may contain a search term. In this case, the index server IS searches for files matching the search term and, if the search is successful, also returns information about the files found.)

The index server IS responds to the request message N1 with a response message N2 which is used to return a list of addresses for peer communication terminals (and possibly information about the file) to the peer communication terminal P2. As address for the peer communication terminal P1, this list contains said peer communication terminal's IP address IP1 and also the IP address IP3 of the peer communication terminal P3. The mobile peer communication terminal P2 is then able to retrieve the file D from the mobile peer communication terminal P1, for example. The file D is then transmitted from the peer communication terminal P1 to the mobile peer communication terminal P2 via the gateway G. (As address for the peer communication terminal P1, it is also possible to transmit a “direct link”, which the mobile peer communication terminal P2 can use to retrieve the file D from the mobile peer communication terminal P1 directly.)

Such request messages may also be sent to the index server IS by further peer communication terminals (not shown in the figure). The index server IS records all request messages arriving on it and ascertains the files for which it receives multiple requests regarding retrieval in the form of request messages. As soon as three request messages relating to the file D have been received by the index server IS, for example, the index server uses a message N3 to transmit an identifier for the file (for example the file name) to the storage peer communication terminal SP. In addition, the index server IS identifies that the file D for which there have already been multiple requests in the past is provided by a plurality of peer communication terminals, namely by the peer communication terminal P1 and by the peer communication terminal P3. The index server IS then sends an inherently known ping message to the mobile peer communication terminal P1. The peer communication terminal P1 responds with a ping response message (e.g. with an “ICMP echo message”), which arrives on the index server IS after a particular time (namely after the ping message response time). This ping message response time is also called the “ping roundtrip time RTT”. In similar fashion, the index server IS also sends a ping message to the peer communication terminal P3 and receives a ping response message from this peer communication terminal P3. In this case, the ping message response time of the mobile peer communication terminal P1 is much longer than the ping message response time of the peer communication terminal P3 arranged in the landline network FN because the communication with the mobile peer communication terminal P1 has to take place via the air interface and delays arise as a result.

Since the peer communication terminal P3 has the shortest ping message response time among the plurality of peer communication terminals P1 and P3, the index server IS also sends the address IP3 of the file-providing peer communication terminal P3 to the storage peer communication terminal SP with the message N3. The storage peer communication terminal SP now has both the identifier of the file and the address IP3 of the peer communication terminal P3 which provides this file. The storage peer communication terminal SP then retrieves the file D identified by the identifier from the peer communication terminal P3 associated with the address IP3. The file is transmitted to the storage peer communication terminal SP from the peer communication terminal P3 using a message N5.

The file D is stored in a memory in the storage peer communication terminal SP. The storage peer communication terminal SP then registers as a provider of this file D with the index server IS. This updates the stock of data on the index server IS with the file D which the storage peer communication terminal SP has recently stored and holds. To this end, the storage peer communication terminal SP sends a registration message N6 to the index server IS. For this registration, the storage peer communication terminal SP uses precisely the type of registration which is used by all peer communication terminals (that is to say by the peer communication terminal P1 or the peer communication terminal P2, for example) to register with the index server IS.

The index server IS then sends a ping message to the storage peer communication terminal SP and receives a ping response message, from which the index server IS ascertains the ping message response time. The ping message response time of the storage peer communication terminal SP is much shorter than the ping message response times of the peer communication terminals P1 and P3, since the storage peer communication terminal SP is arranged in the stationary part of the mobile radio network operator's operator network and is connected to the index server via the interface S. From the very short ping message response time, the index server IS identifies that the peer communication terminal registered as provider of the file D is the storage peer communication terminal SP. The index server then arranges the address IP4 of the storage peer communication terminal SP at the first position in an address list which is provided for holding addresses for peer communication terminals which provide the file D. If addresses for other peer communication terminals providing the file D have already been arranged (i.e. are present) in this address list previously, then the index server IS deletes these addresses which are already present before it arranges the address IP4 of the storage peer communication terminal SP at the first position in the address list. This ensures that this address list is used to transmit only the address IP4 of the storage peer communication terminal SP to peer communication terminals which are requesting the file D.

As soon as the index server receives a further request message relating to the file D (in the exemplary embodiment a message N8 from the mobile peer communication terminal P2), the index server IS returns the address list to the requesting peer communication terminal P2. The requesting peer communication terminal P2 takes the address IP4 of the storage peer communication terminal SP from the first position in the address list and then retrieves the file from the storage peer communication terminal SP. The storage peer communication terminal transmits the file to the mobile peer communication terminal P2 via the gateway G. In this case, the file needs to be transmitted only once via an air interface, namely via the air interface between the gateway G and the mobile peer communication terminal P2. In doing this, the file D is transmitted within the operator network 1.

The storage peer communication terminal SP converts long data transmission blocks (chunks), which are used when transmitting the file D in communication landline networks or in the landline part of the mobile radio network, into short data transmission blocks, which are used for the mobile peer communication terminals. To this end, the peer communication terminal has a converter which converts the long data transmission blocks into the short data transmission blocks, and vice versa.

The index server IS is connected to the storage peer communication terminal SP via an interface S—as explained above—which the index server uses to send an identifier for the file and an address for the peer communication terminal providing this file to the storage peer communication terminal SP. The storage peer communication terminal SP is designed such that, following receipt of the identifier and of the address, it automatically retrieves the file characterized by the identifier from the peer communication terminal associated with the address and stores this file in its memory. The storage peer communication terminal SP then automatically registers as a provider of this file with the index server IS. This registration is effected not via the interface S but rather via the communication connection (symbolized by a dash-dot line in the figure) for signaling messages. Following successful registration, the index server IS, upon receiving a further request message relating to the file, provides the requesting peer communication terminal only with the address of the storage peer communication terminal SP and thus allows the requesting peer communication terminal to retrieve the file from the storage peer communication terminal SP.

One particular advantage is that the storage peer communication terminal SP registers as a provider of the file with the index server IS like an ordinary peer communication terminal. This means that the index server IS does not need to monitor separately which files are stored on the storage peer communication terminal SP. The index server IS merely ascertains—as illustrated above—from the ping message response time that the new provider of the file is the storage peer communication terminal SP, and it then puts the address of the storage peer communication terminal SP at the first position in the address list. Subsequently, the storage peer communication terminal is treated like an ordinary peer communication terminal.

The storage peer communication terminal SP is a cache memory which is connected to the index server IS and which simulates functionalities of peer communication terminals. In particular, the storage peer communication terminal SP simulates an “ordinary” peer communication terminal when retrieving the file D from the peer communication terminal P3 which provides the file; similarly, the storage peer communication terminal SP then registers as a provider of the file with the index server like an “ordinary” peer communication terminal.

The method described and the arrangement described have a series of advantages:
the method and the arrangement are easy to scale, since a plurality of storage peer communication terminals can be associated with an index server if needed.
The use of the storage peer communication terminal with characteristics of a cache memory and of a peer communication terminal allows the method and the arrangement to be added to already existing peer-to-peer data transmission methods and arrangements with little complexity.
The use of the storage peer communication terminal SP keeps the data traffic largely local in the operating network 1 of the mobile radio network operator. By avoiding data transmissions across operator networks, the network operator's costs are reduced and hence favorable prices can be achieved for the users.
An advantage for the users of the peer communication terminals P1, P2 and P3 is that the peer-to-peer data transmission takes place in very stable fashion, since the file D is held in the storage peer communication terminal SP arranged in the landline part of the mobile radio network and does not need to be transmitted to the landline part from a further mobile peer communication terminal using a further air interface. Higher data transmission speeds are therefore also achieved.
Further significant shortening of the data transmission times is obtained when the mobile peer communication terminals are linked to the mobile radio landline part asymmetrically, by virtue of the inventive method involving the file being transmitted from the storage peer communication terminal SP to the mobile peer communication terminal P2 using the (generally relatively high) download data transmission rate; the (generally comparatively low) asymmetric upload data transmission rate of a mobile peer communication terminal providing the file does not impair the peer-to-peer data transmission.
As soon as the file is held in the storage peer communication terminal SP, besides the storage peer communication terminal SP only the peer communication terminal downloading the file is involved in the peer-to-peer data transmission and has to bear the costs of data transmission; there are no transmission costs for other mobile peer communication terminals, for example.
Overall, the use of the storage peer communication terminal significantly reduces the loading of the mobile radio network by peer-to-peer data traffic.

1. A method for allowing peer-to-peer data transmission between peer communication terminals with the following steps:
automatically retrieving a file, for which multiple requests regarding retrieval have been sent to an index server by at least one peer communication terminal, from a peer communication terminal
providing the file to a storage peer communication terminal, and
storing the file in the storage peer communication terminal,
wherein the storage peer communication terminal registers as a provider of the file with the index server, and
the index server, upon receiving a further request relating to the file, provides the requesting peer communication terminal with an address for the storage peer communication terminal to allow the requesting peer communication terminal to retrieve the file from the storage peer communication terminal.

2. The method as claimed in claim 1, wherein automatically retrieving the file further comprises:
sending an identifier for the file and an address for the peer communication terminal from the index server, and
retrieving, at the storage peer communication terminal, the file indicated by the identifier from the peer communication terminal associated with the address.

3. The method as claimed in claim 1, wherein:
the index server, upon receiving the further request relating to the file, provides the requesting peer communication terminal with the address of the storage peer communication terminal by virtue of,
the index server arranging the address of the storage peer communication terminal at the first position in an address list which is provided for holding addresses for peer communication terminals which provide the file, and
the index server transmitting this address list to the requesting peer communication terminal.

4. The method as claimed in claim 3, wherein:
if addresses are already arranged at a second, third and/or lower listed positions, the index server deletes the addresses.

5. The method as claimed in claim 1, wherein the peer communication terminals are mobile terminals in a mobile radio network.

6. The method as claimed in claim 1, wherein
a the storage peer communication terminal is arranged in a stationary part of a mobile radio network.

7. The method as claimed in claim 1, wherein a the storage peer communication terminal is arranged in a same operator network as the index server.

8. The method as claimed in claim 1, wherein:
the index server identifies the storage peer communication terminal from a ping message response time, which is shorter than other peer communication terminals.

9. The method as claimed in claim 1, wherein:
if the file which has already received multiple requests is provided by a plurality of peer communication terminals then the file is retrieved by the storage peer communication terminal which has a shortest ping message response time of the plurality of selected peer communication terminals.

10. The method as claimed in claim 1, wherein:
the storage peer communication terminal converts short data transmission blocks, which are used by peer communication terminals in the form of mobile terminals, into long data transmission blocks, which are used by peer communication terminals arranged in stationary parts of telecommunication networks, and vice versa.

11. A system comprising:
a storage peer communication terminal, and
an index server, wherein:
the index server is designed to send an identifier for a file and an address for a peer communication terminal which provides the file to the storage peer communication terminal,
the storage peer communication terminal is designed to automatically retrieve the file identified by the identifier from the peer communication terminal associated with the address,
the storage peer communication terminal is designed to automatically store file,
the storage peer communication terminal is designed to automatically register as a provider of the file with the index server, and
the index server is designed such that, upon receiving a further request which relates to the file, it provides the requesting peer communication terminal with an address for the storage peer communication terminal in order to allow the requesting peer communication terminal to retrieve the file from the storage peer communication terminal.

12. The arrangement as claimed in claim 11, wherein the peer communication terminal is a mobile terminal in a mobile radio network.

13. The arrangement as claimed in claim 11, wherein the storage peer communication terminal is arranged in a stationary part of a mobile radio network.

14. The arrangement as claimed in claim 11, wherein the storage peer communication terminal is arranged in a same operator network as the index server.

15. The arrangement as claimed in claim 11, wherein:
the storage peer communication terminal is designed to convert short data transmission blocks, which are used by peer communication terminals in the form of mobile terminals, into long data transmission blocks, which are used by peer communication terminals arranged in stationary parts of telecommunication networks, and vice versa.
